(19) United States
(12) Patent Application Publication
(10) Pub. No.: US 2026/0287994 A1
(43) Pub. Date: Sep. 24, 2026

(54) LIGHT SOURCE ASSEMBLY, METHOD FOR MANUFACTURING SAME, AND PROJECTION DEVICE

(71) Applicants: Beijing BOE Display Technology Co., Ltd., Beijing (CN); BOE Technology Group Co., Ltd., Beijing (CN)

(72) Inventors: Wei ZHANG, Beijing (CN); Guangquan WANG, Beijing (CN); Yujie WANG, Beijing (CN); Xi LI, Beijing (CN); Xiaolong LIU, Beijing (CN); Dalin DONG, Beijing (CN); Yu YANG, Beijing (CN); Qirui TAN, Beijing (CN); Jianmin LU, Beijing (CN); Peng WU, Beijing (CN); Tianyang HAN, Beijing (CN); Weichao ZHANG, Beijing (CN)

(21) Appl. No.: 19/477,069

(22) PCT Filed: Mar. 13, 2024
(86) PCT No.: PCT/CN2024/081415

§ 371 Date: Oct. 20, 2025

(30) Foreign Application Priority Data
Apr. 26, 2023 (CN) 202310466575.1

(51) Int. Cl. G03B 21/20; G03B 21/00

(52) U.S. Cl. CPC G03B 21/204; G03B 21/006; G03B 21/2073

(57) ABSTRACT

Disclosed is a light source assembly. The light source assembly comprises a light source, a base disposed on a backlight side of the light source, and a polarization beam-splitting layer disposed on a light-emitting side of the light source. The polarization beam-splitting layer is configured to reflect a light beam that meets a first condition to the light source, and transmit a light beam that does not meet the first condition. The light source is configured to emit a first light beam and emit a second light beam based on the light beam in the second polarization direction reflected by the polarization beam-splitting layer.

### CROSS-REFERENCE TO RELATED APPLICATIONS

The present disclosure is a U.S. national phase application based on PCT/CN 2024/081415, filed on Mar. 13, 2024, which claims priority to Chinese Patent Application No. 202310466575.1, filed on Apr. 26, 2023, and entitled “LIGHT SOURCE ASSEMBLY, METHOD FOR MANUFACTURING SAME, AND PROJECTION DEVICE”, both of which are incorporated by reference herein.

### TECHNICAL FIELD

The present disclosure relates to the field of projection display technologies, and in particular, relates to a light source assembly, a method for manufacturing the same, and a projection device.

### BACKGROUND

A projection device, also referred to as a projector, is a device that projects images or videos onto a screen for display and is widely used in scenarios such as offices and homes.

### SUMMARY

Embodiments of the present disclosure provide a light source assembly, a method for manufacturing the same, and a projection device. The technical solutions are as follows.

In one aspect, the light source assembly is provided. The light source assembly includes: a base, a light source, and a polarization beam-splitting layer, wherein
the light source is configured to emit a first light beam, the first light beam including a light beam in a first polarization direction and a light beam in a second polarization direction;
the polarization beam-splitting layer is disposed on a light-emitting side of the light source and is configured to reflect a light beam that meets a first condition to the light source, and transmit a light beam that does not meet the first condition, wherein the first condition includes an incident angle being greater than or equal to an angle threshold, and a polarization direction being the second polarization direction;
the light source is further configured to emit a second light beam based on the light beam in the second polarization direction reflected by the polarization beam-splitting layer, the second light beam including a light beam in the first polarization direction and a light beam in the second polarization direction; and
the base is disposed on a backlight side of the light source and outside a transmission path of a light beam between the light source and the polarization beam-splitting layer, and the base is connected to the light source and the polarization beam-splitting layer.

In some embodiments, the polarization beam-splitting layer includes at least one birefringent layer, the at least one birefringent layer being in one-to-one correspondence with at least one wavelength;
the birefringent layer is configured to reflect a light beam that meets a second condition to the light source, and transmit a light beam that does not meet the second condition, wherein the second condition includes a wavelength being a wavelength that corresponds to the birefringent layer, an incident angle being less than or equal to an angle threshold, and a polarization direction being the second polarization direction; and
the first condition further includes a wavelength belonging to the at least one wavelength.

In some embodiments, the polarization beam-splitting layer further includes two transparent protective layers; and
the at least one birefringent layer is disposed between the two transparent protective layers.

In some embodiments, the base is provided with a groove, the light source is disposed within the groove, and the polarization beam-splitting layer covers an opening of the groove.

In some embodiments, the base includes a substrate, an adhesive layer, and a support layer; and
the substrate and the support layer are connected via the adhesive layer, and a bottom surface of the groove is disposed on a surface, proximal to the adhesive layer, of the substrate.

In some embodiments, a total thickness of the adhesive layer and the support layer is greater than a thickness of the light source.

In some embodiments, a material of the base is a thermally conductive material, and the light source assembly further includes a heat sink connected to the base.

In some embodiments, the light source includes a light-emitting chip and a phosphor layer that covers a light-emitting side of the light-emitting chip;
the light-emitting chip is configured to emit an initial light beam; and
the phosphor layer is configured to:
obtain the first light beam based on the initial light beam, and emit the first light beam from one side, distal to the light-emitting chip, of the phosphor layer; and
emit, based on a light beam reflected by the polarization beam-splitting layer, the second light beam from one side, distal to the light-emitting chip, of the phosphor layer.

In some embodiments, the angle threshold is 30°.

In another aspect, a projection device is provided. The projection device includes: the light source assembly as described in the above aspect and a light modulation assembly, wherein
the light modulation assembly is configured to modulate a light beam from the light source assembly into an image light beam, and project the image light beam.

In some embodiments, a light beam emitted by the light source assembly includes a light beam in a first polarization direction and a light beam in a second polarization direction, and the light modulation assembly includes a liquid crystal display (LCD) panel; and
the LCD panel is configured to modulate the light beam in the first polarization direction from the light source assembly to obtain the image light beam.

In some embodiments, the light modulation assembly further includes a polarizer, wherein
the polarizer is disposed on a light path between the light source assembly and the LCD panel, and the polarizer is configured to transmit light in the first polarization direction.

In some embodiments, the polarizer is further configured to absorb or reflect light in the second polarization direction.

In some embodiments, the light modulation assembly further includes a first reflector and a second reflector, and the projection device further includes a projection lens, wherein
the first reflector is disposed on a light path between the light source assembly and the LCD panel, and the second reflector is disposed on a light path between the LCD panel and the projection lens.

In some embodiments, a light path between the light source assembly and the first reflector is parallel to a light path between the projection lens and the second reflector.

In some embodiments, a transmission direction of light on the light path between the light source assembly and the first reflector is opposite to a transmission direction of light on the light path between the projection lens and the second reflector.

In some embodiments, the light modulation assembly further includes at least one of a first lens assembly and a second lens assembly, wherein
the first lens assembly is disposed on a light path between the first reflector and the LCD panel, and the second lens assembly is disposed on a light path between the second reflector and the LCD panel.

In some embodiments, the light modulation assembly further includes a heat insulation element, wherein
the heat insulation element is disposed on the light path between the light source assembly and the LCD panel.

In some embodiments, the light modulation assembly further includes a light collecting element, wherein the light collecting element is disposed on the light path between the light source assembly and the LCD panel.

The present disclosure takes as an example where the projection device includes a light source assembly, a light collecting element, a first reflector, a first lens assembly, a heat insulation element, a polarizer, an LCD panel, a second lens assembly, a second reflector, and a projection lens. In this case, a light beam emitted by the light source assembly sequentially passes through the light collecting element, the first reflector, the first lens assembly, the heat insulation element, the polarizer, the LCD panel, the second lens assembly, the second reflector, and the projection lens. It can be understood that the projection device may also not include at least one of the light collecting element, the first reflector, the first lens assembly, the heat insulation element, the polarizer, the second lens assembly, or the second reflector.

In yet another aspect, a method for manufacturing a light source assembly is provided. The method includes:
assembling a light source assembly that includes a base, a light source, and a polarization beam-splitting layer, wherein the light source assembly is the light source assembly as described in the above aspect.

In some embodiments, the base is provided with a groove, the light source is disposed within the groove, and the polarization beam-splitting layer covers an opening of the groove; the base includes a substrate, an adhesive layer, and a support layer; and
assembling the light source assembly that includes the base, the light source, and the polarization beam-splitting layer includes:
arranging the light source on the substrate;
attaching the adhesive layer onto the support layer;
obtaining the base by laminating the support layer attached with the adhesive layer and the substrate provided with the light source together via the adhesive layer, wherein a bottom surface of the groove is disposed on a surface, proximal to the adhesive layer, of the substrate; and
obtaining the light source assembly by laminating the base and the polarization beam-splitting layer together.

In some embodiments, the base is provided with a groove, the light source is disposed within the groove, and the polarization beam-splitting layer covers an opening of the groove; the base includes a substrate, an adhesive layer, and a support layer; and
assembling the light source assembly that includes the base, the light source, and the polarization beam-splitting layer includes:
arranging the light source on the substrate;
attaching the adhesive layer onto the substrate provided with the light source;
obtaining the base by laminating the substrate attached with the adhesive layer and the support layer together via the adhesive layer, wherein a bottom surface of the groove is disposed on a surface, proximal to the adhesive layer, of the substrate; and
obtaining the light source assembly by laminating the base and the polarization beam-splitting layer together.

In some embodiments, the base is provided with a groove, the light source is disposed within the groove, and the polarization beam-splitting layer covers an opening of the groove; the base includes a substrate, an adhesive layer, and a support layer; and
assembling the light source assembly that includes the base, the light source, and the polarization beam-splitting layer includes:
arranging the light source on the substrate;
attaching the adhesive layer onto the substrate provided with the light source;
laminating the support layer and the polarization beam-splitting layer together; and
obtaining the light source assembly by laminating the support layer laminated with the polarization beam-splitting layer and the substrate attached with the adhesive layer together via the adhesive layer, wherein a bottom surface of the groove is disposed on a surface, proximal to the adhesive layer, of the substrate.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic structural diagram of a projection device according to some embodiments of the present disclosure;

FIG. 2 is a schematic structural diagram of a light source assembly according to some embodiments of the present disclosure;

FIG. 3 is a top view of a light source assembly according to some embodiments of the present disclosure;

FIG. 4 is a schematic structural diagram of another light source assembly according to some embodiments of the present disclosure;

FIG. 5 is a schematic structural diagram of a polarization beam-splitting layer according to some embodiments of the present disclosure;

FIG. 6 is a schematic structural diagram of yet another light source assembly according to some embodiments of the present disclosure;

FIG. 7 is a flowchart of a method for manufacturing a light source assembly according to some embodiments of the present disclosure;

FIG. 8 is a schematic diagram of a structure formed after arranging a light source on a substrate according to some embodiments of the present disclosure;

FIG. 9 is a schematic diagram of a structure formed after attaching an adhesive layer on a support layer according to some embodiments of the present disclosure;

FIG. 10 is a schematic diagram of a local structure of a light source assembly according to some embodiments of the present disclosure;

FIG. 11 is a top view of another light source assembly according to some embodiments of the present disclosure;

FIG. 12 is a flowchart of another method for manufacturing a light source assembly according to some embodiments of the present disclosure;

FIG. 13 is a schematic diagram of a structure formed after attaching an adhesive layer on a substrate provided with a light source according to some embodiments of the present disclosure;

FIG. 14 is a flowchart of yet another method for manufacturing a light source assembly according to some embodiments of the present disclosure; and

FIG. 15 is a schematic diagram of a structure obtained after laminating a support layer and a polarization beam-splitting layer together according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

In the related art, a projection device may include a light source, a light collecting element, a liquid crystal display (LCD) panel, and a projection lens. The light collecting element can concentrate the light beam emitted by the light source onto the LCD panel, such that the LCD panel modulates the light into an image light beam. The image light beam modulated by the LCD panel can be projected onto a projection screen through the projection lens to realize the projection display of a projection image.

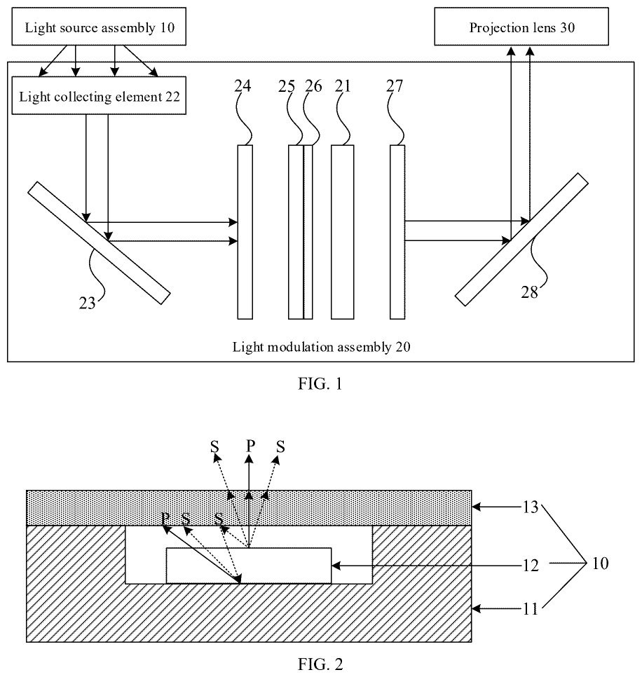

FIG. 1 is a schematic structural diagram of a projection device according to some embodiments of the present disclosure. As shown in FIG. 1, the projection device includes a light source assembly 10 and a light modulation assembly 20. The light modulation assembly 20 is configured to modulate a light beam from the light source assembly 10 into an image light beam, and project the image light beam.

Referring to FIG. 1, the light modulation assembly 20 may include an LCD panel 21. The light beam emitted by the light source assembly 10 includes a light beam in a first polarization direction and a light beam in a second polarization direction. The LCD panel 21 is configured to modulate the light beam in the first polarization direction from the light source assembly 10 to obtain an image light beam.

Among the light beams emitted by the light source assembly 10, only the light beam in the first polarization direction can pass through the LCD panel 21 and be modulated into the image light beam for projection display.

With continued reference to FIG. 1, the light modulation assembly 20 may further include a light collecting element 22, a first reflector 23, a first lens assembly 24, a heat insulation element 25, a polarizer 26, a second lens assembly 27, and a second reflector 28. The projection device may further include a projection lens 30. After passing through the components in sequence, the light emitted by the light source assembly 10 is emitted in the form of an image light beam to form a projection image, which is then projected onto a projection screen by the projection lens 30 to realize the display of the projection image.

The light collecting element 22 is disposed on a light path between the light source assembly 10 and the first reflector 23; the light collecting element 22 is configured to converge the light beam emitted by the light source assembly 10 and then emit the converged light beam to the first reflector 23.

The first reflector 23 is disposed on a light path between the light collecting element 22 and the first lens assembly 24; the first reflector 23 can reflect the light beam emitted by the light collecting element 22 to the first lens assembly 24.

The first lens assembly 24 is disposed on a light path between the first reflector 23 and the heat insulation element 25. The first lens assembly 24 can modulate the light beam reflected by the first reflector 23 into an approximately collimated light beam.

The heat insulation element 25 is disposed on a light path between the first lens assembly 24 and the polarizer 26, that is, on a light-incident side of the LCD panel 21. The heat insulation element 25 can reduce the influence of thermal radiation generated by the light beam emitted by the first lens assembly 24 on the LCD panel 21, thereby ensuring that the LCD panel 21 can operate normally. The heat insulation element 25 may include heat insulation glass (not shown in FIG. 1).

The polarizer 26 is disposed on a light path between the heat insulation element 25 and the LCD panel 21. For example, referring to FIG. 1, the polarizer 26 is attached to one side, proximal to the LCD panel 21, of the heat insulation element 25. The polarizer 26 is configured to transmit light in the first polarization direction. In some embodiments, the polarizer 26 also absorbs or reflects light in the second polarization direction.

It can be understood that, by arranging the polarizer 26 on the light-incident side of the LCD panel 21, the light transmitted to the LCD panel 21 can be further filtered, to prevent the light in the second polarization direction emitted by the light source assembly 10 from being transmitted to the LCD panel 21, thereby increasing the proportion of light in the first polarization direction transmitted to the LCD panel 21. Thus, the thermal radiation generated by the light beam irradiated on the LCD panel 21 can be further reduced.

The second lens assembly 27 is disposed on a light path between the LCD panel 21 and the second reflector 28. The second lens assembly 27 can modulate the image light beam obtained by the modulation of the LCD panel 21 into an approximately collimated light beam and emit the approximately collimated light beam to the second reflector 28. The first lens assembly 24 and the second lens assembly 27 may each include at least one lens, and the at least one lens may be a Fresnel lens.

The second reflector 28 is disposed on a light path between the second lens assembly 27 and the projection lens 30. The second reflector 28 can reflect the image light beam emitted by the second lens assembly 27 to the projection lens 30. The projection lens 30 can then project the image light beam onto the projection screen, so as to realize the display of the projection image.

In some embodiments, as shown in FIG. 1, the light path between the light source assembly 10 and the first reflector 23 is parallel to the light path between the projection lens 30 and the second reflector 28. In some embodiments, the directions of light transmission in the two light paths are opposite. It can be understood that, by arranging the first reflector 23 and the second reflector 28 in a light path between the light source assembly 10 and the projection lens 30, the light path can be folded, thereby reducing the volume of the projection device and thus realizing the miniaturization of the projection device.

It should be noted that the above projection device may include at least one of the light collecting element 22, the first reflector 23, the first lens assembly 24, the heat insulation element 25, the polarizer 26, the second lens assembly 27, or the second reflector 28. That is, the number of elements included in the projection device may be reduced, and the arrangement positions of the elements may also be adjusted, which is not limited in the embodiments of the present disclosure. However, it is necessary to ensure that the light collecting element 22, the first reflector 23, the first lens assembly 24, the heat insulation element 25, and the polarizer 26 are all disposed on a light path between the light source assembly 10 and the LCD panel 21, and that the second lens assembly 27 and the second reflector 28 are disposed on a light path between the LCD panel 21 and the projection lens 30.

It can be understood that, since only a portion of the light beam emitted by the light source assembly 10 (i.e., the light beam in the first polarization direction) is used for projection display, the utilization rate of the light beam emitted by the light source assembly 10 in the projection device is low, and the brightness of the projection image projected by the projection device (i.e., the brightness of the projection device) is also low. Based on this, how to improve the brightness of the projection device is an urgent problem to be solved.

In the related art, the brightness of projection devices is mainly improved by the following methods.

(1) Increasing the brightness of the light source.

At present, in the related art, the brightness of the light source is mainly increased by improving the luminous efficacy or the power of the light source. The heat dissipation performance of the light source assembly is a major factor affecting the luminous efficacy of the light source; the luminous efficacy of the light source is positively correlated with the heat dissipation performance of the light source assembly. Therefore, by optimizing the heat dissipation performance of the projection device, the luminous efficacy of the light source can be improved, thereby allowing the light source to achieve higher brightness under the original driving power. However, limited by the current level of technology, the luminous efficacy cannot be improved to an ideal level. As for the method of increasing the power of the light source, since the luminous efficacy is negatively correlated with the power of the light source, increasing the power of the light source to increase the brightness thereof will result in a decrease in the luminous efficacy of the light source.

(2) Reducing optical loss.

The main methods to reduce optical loss include: 1. applying coatings on the surfaces of optical elements inside the projection device; 2. improving the light transmittance of the LCD panel; 3. replacing optical elements with higher luminous efficacy, and the like. However, such methods offer only a limited degree of improvement in the brightness of the projection device.

(3) Adjusting the internal operating temperature of the projection device.

By adjusting the internal temperature of the projection device to an optimal operating temperature, the luminous efficacy of the light source assembly can be increased, thereby improving the brightness of the projection device. Currently, the elements inside a projection device that are greatly affected by temperature are the light source in the light source assembly 10 and the LCD panel 21 in the light modulation assembly 20. Ambient temperature will affect the light transmittance of the LCD panel 21 (i.e., the emission rate of the image light beam). The higher the light transmittance, the higher the brightness of the projection device. The optimal light transmittance of the LCD panel 21 can be achieved when the operating ambient temperature thereof is 26° C. However, the optimal operating temperature for peak luminous efficacy of the light source in the light source assembly 10 is 0° C. For every 10° C. increase in the internal temperature of the projection device, the luminous efficacy of the light source decreases by about 10%. Therefore, at present, it is not possible to adjust the internal temperature of the projection device in a way that ensures the light transmittance of the LCD panel 21 while also considering the luminous efficacy of the light source.

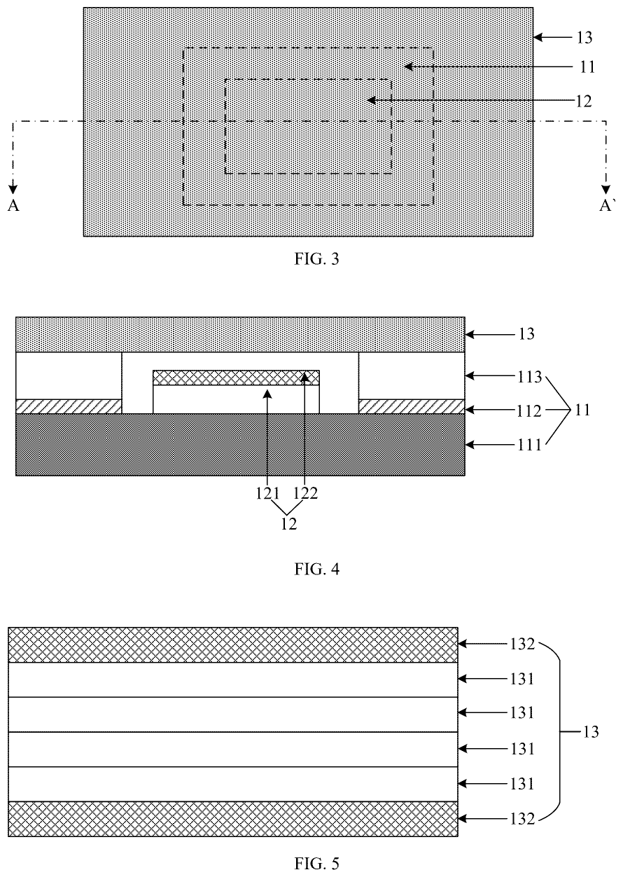

FIG. 2 is a schematic structural diagram of a light source assembly according to some embodiments of the present disclosure. The light source assembly is applicable to a projection device, for example, the light source assembly is applicable to the projection device shown in FIG. 1. Referring to FIG. 2, the light source assembly 10 includes a base 11, a light source 12, and a polarization beam-splitting layer 13. FIG. 3 is a top view of the light source assembly 10, and FIG. 2 is a sectional view along direction AA′ in the top view shown in FIG. 3.

The polarization beam-splitting layer 13 is disposed on a light-emitting side of the light source 12, and the base 11 is disposed on a backlight side of the light source 12 and outside the transmission path of the light beam between the light source 12 and the polarization beam-splitting layer 13. The base 11 is connected to the light source 12 and the polarization beam-splitting layer 13.

The light source 12 is configured to emit a first light beam, which includes a light beam P in a first polarization direction and a light beam S in a second polarization direction. The polarization beam-splitting layer 13 is configured to reflect a light beam that meets a first condition to the light source 12, and transmit a light beam that does not meet the first condition. The first condition includes: an incident angle being less than or equal to an angle threshold, and a polarization direction being the second polarization direction. The light source 12 is further configured to emit a second light beam based on the light beam S in the second polarization direction reflected by the polarization beam-splitting layer 13. The second light beam includes the light beam P in the first polarization direction and the light beam S in the second polarization direction.

The light beam P in the first polarization direction can pass through the LCD panel 21 in the light modulation assembly 20, and the light beam P in the first polarization direction may also be referred to as useful light. The light beam S in the second polarization direction cannot pass through the LCD panel 21, and thus, the light beam S in the second polarization direction is also referred to as useless light.

According to the technical solution provided in the present disclosure, the brightness of the projection device is improved by increasing the utilization rate of the polarized light beams emitted by the light source 12. In the solution provided in the present disclosure, the polarization beam-splitting layer 13, which is arranged on the light-emitting side of the light source 12, can reflect, among the light beams emitted by the light source 12, a light beam S in the second polarization direction that meets the first condition to the light source 12 for depolarization processing. The light source 12, by depolarizing the light beam S in the second polarization direction, can convert a portion of the light beam S in the second polarization direction into a light beam P in the first polarization direction, and emit the light beam in the first polarization direction again.

Based on the above analysis, it can be seen that the light beam S in the second polarization direction among the light beams emitted by the light source 12 that meets the first condition can, after multiple depolarization and reflection actions by the light source 12, eventually all be converted into a light beam P in the first polarization direction and emitted from the polarization beam-splitting layer 13. Thus, the proportion of the light beam P in the first polarization direction among the light beams emitted by the light source assembly 10 to the light modulation assembly 20 can be effectively increased, thereby improving the brightness of the image light beam emitted by the light modulation assembly 20, and thus increasing the brightness of the projection image projected by the projection device.

It can be understood that, under the premise that the total amount of light beams emitted by the light source 12 is constant, there will be a certain amount of optical loss as the light beams emitted by the light source 12 pass through each element in the light modulation assembly 20 and finally are emitted through the projection lens 30; that is, only a portion of the light beams emitted by the light source 12 can ultimately be modulated into image light beams and emitted through the projection lens 30. Based on this, in the solution provided by the present disclosure, by arranging the polarization beam-splitting layer 13 in the light source assembly 10 and on the light-emitting side of the light source 12 (that is, between the light source 12 and the light collecting element 22), a portion of the light beam S in the second polarization direction among the light beams emitted by the light source 12 can be converted into the light beam P in the first polarization direction and emitted before the light beams emitted by the light source 12 are attenuated in the light modulation assembly 20, thereby increasing the proportion of the light beam P in the first polarization direction among the light beams emitted by the light source assembly 10, and thus improving the brightness of the projection image projected by the projection device.

In summary, the embodiments of the present disclosure provide a light source assembly, which includes a light source, a base disposed on a backlight side of the light source, and a polarization beam-splitting layer disposed on a light-emitting side of the light source. The polarization beam-splitting layer can reflect, among the light beams emitted by the light source, a light beam in the second polarization direction that meets the first condition, back to the light source. The light source can convert a portion of the light beam in the second polarization direction, reflected by the polarization beam-splitting layer, into a light beam in a first polarization direction and emit the light beam. Therefore, the utilization rate of the light beam in the second polarization direction emitted by the light source can be effectively improved, thereby increasing the brightness of the projection image projected by the projection device.

Moreover, since the polarization beam-splitting layer is positioned close to the light-emitting side of the light source, the utilization rate of the light beam in the second polarization direction emitted by the light source can be further improved, thus further increasing the brightness of the projection image projected by the projection device.

It can be understood that the angle threshold in the first condition may be a predetermined fixed angle. For example, the angle threshold may be a value of a total reflection angle when the light beam emitted by the light source 12 is incident on the polarization beam-splitting layer 13. Exemplarily, the value of the total reflection angle is 30°; that is, the angle threshold is 30°.

The following will introduce, in sequence, a plurality of elements included in the light source assembly 10 in conjunction with the accompanying drawings and relevant examples.

### 1. Light Source 11

As shown in FIG. 4, the light source 12 includes a light-emitting chip 121 and a phosphor layer 122 that covers the light-emitting side of the light-emitting chip 121.

The light-emitting chip 121 is configured to emit an initial light beam. The phosphor layer 122 is configured to obtain the first light beam based on the initial light beam, and emit the first light beam from one side, distal to the light-emitting chip 121, of the phosphor layer 122; and emit, based on a light beam reflected by the polarization beam-splitting layer 13, the second light beam from one side, distal to the light-emitting chip 121, of the phosphor layer 122.

The color of the initial light beam may be different from that of the first light beam. It can be understood that the light emitted by the light-emitting chip 121 is generally non-white light, while the color of the light beam used for modulation by the LCD panel 21 is generally white light. Based on this, the phosphor layer 122 may be arranged on the light-emitting side of the light-emitting chip 121, such that the phosphor layer 122 can convert the light emitted by the light-emitting chip 121 into white light. For example, the initial light beam emitted by the light-emitting chip 121 is blue light, and the phosphor layer 122 is a yellow phosphor layer. The blue light, after passing through the yellow phosphor layer, can be emitted in the form of white light.

Moreover, the phosphor layer 122 also has the characteristic of converting the polarization direction of polarized light, which may also be referred to as a depolarization characteristic. After the light beam in the second polarization state, reflected by the polarization beam-splitting layer 13, is incident on the phosphor layer 122, the polarization direction of a portion of the light beam will change to the first polarization direction, while the polarization direction of another portion of the light beam will remain as the second polarization direction. Subsequently, the light beams in the first polarization direction and the second polarization direction can be emitted again by the phosphor layer 122 to the polarization beam-splitting layer 13. Based on this, the conversion rate of the light beam in the second polarization direction emitted by the light source 12 can be increased, thereby achieving the effect of improving luminous efficacy.

### 2. Polarization Beam-Splitting Layer 13

Referring to FIG. 5, the polarization beam-splitting layer 13 includes at least one birefringent layer 131. The at least one birefringent layer 131 is in one-to-one correspondence with at least one wavelength. The birefringent layer 131 is configured to reflect a light beam that meets a second condition to the light source 12 and transmit a light beam that does not meet the second condition. The second condition includes a wavelength being a wavelength that corresponds to the birefringent layer, an incident angle being less than or equal to an angle threshold, and a polarization direction being the second polarization direction. The first condition may further include a wavelength belonging to the at least one wavelength. Based on this, the second condition may also be expressed as meeting the first condition, and a wavelength being a wavelength that corresponds to the birefringent layer.

In the embodiments of the present disclosure, the birefringent layer 131 having an anisotropic characteristic may be used to realize the polarization beam-splitting of the light beam emitted by the light source 12. The light beam emitted by the light source 13 is generally non-polarized light. After the non-polarized light is incident on the at least one birefringent layer 131 in the polarization beam-splitting layer 13, the non-polarized light can be split into a light beam in the first polarization direction and a light beam in the second polarization direction. Based on the principle of birefringence, the refractive indices of the light beam in the first polarization direction and the light beam in the second polarization direction are different in the at least one birefringent layer 131, such that the propagation directions and propagation speeds of the light beam in the first polarization direction and the light beam in the second polarization direction are different in the at least one birefringent layer 131. In this way, the non-polarized light emitted by the light source 12 can be emitted as two light beams with different polarization directions after passing through the polarization beam-splitting layer 13.

During the transmission process of the light beam emitted by the light source 13 in the at least one birefringent layer 131, the transmission and reflection characteristics of different birefringent layers 131 with respect to the light beam are not completely identical. It can be understood that the light beam emitted by the light source 12 may include a light beam of at least one wavelength. After the light beam of at least one wavelength is incident on the at least one birefringent layer 131, the light beam, with a wavelength corresponding to one birefringent layer 131 and meeting the first condition, can be reflected to the light source 12 for depolarization. That is, the at least one birefringent layer 131 in the polarization beam-splitting layer 13 can reflect a light beam in the second polarization state to the light source 12, but the wavelengths of the light beams reflected by the at least one birefringent layer 131 are different from each other. Thus, the reflection and depolarization of light beams in the second polarization state of different wavelengths can be achieved.

It can be understood that the polarization beam-splitting layer 13 may include a relatively large number of birefringent layers 131, so as to achieve the reflection and depolarization of light beams in the second polarization state at a relatively large number of wavelengths. When the number of birefringent layers 131 included in the polarization beam-splitting layer 13 is sufficiently large, the polarization beam-splitting layer 13 can achieve the reflection of light beams of full-spectrum wavelengths that meet the second condition.

In some embodiments, as shown in FIG. 5, the polarization beam-splitting layer 13 further includes two transparent protective layers 132. The at least one birefringent layer 131 is disposed between the two transparent protective layers 132. The two transparent protective layers may both be cellulose triacetate (TAC) thin films, serving to protect the birefringent layer 131.

### 3. Base 11

In the embodiments of the present disclosure, the base 11 may be provided with a special structure based on the connection requirements between the base 11, the light source 12, and the polarization beam-splitting layer 13. The embodiments of the present disclosure do not limit the structural style of the base.

For example, to meet the restrictive condition that the base 11 is disposed on the backlight side of the light source 12 and outside the transmission path of the light beam between the light source 12 and the polarization beam-splitting layer 13, and the base 11 is connected to the light source 12 and the polarization beam-splitting layer 13, referring to FIG. 4, the base 11 is provided with a groove, the light source 12 is disposed within the groove, and the polarization beam-splitting layer 13 covers the opening of the groove. It can be understood that the base 11 may also be provided with structures other than a groove, which is not limited in the embodiments of the present disclosure. Moreover, the base 11 may also not be provided with a groove. In this case, the shape of the polarization beam-splitting layer 13 needs to be designed differently from the structure shown in FIG. 3. For example, the polarization beam-splitting layer 13 is provided with a groove with an opening facing the light source 12.

In the case that the base 11 is provided with a groove, the groove can be implemented in various ways. For example, the base 11 is an element formed by assembling a plurality of components and provided with a groove. Alternatively, the base 11 is an element with a groove structure obtained by etching one component (for example, a substrate 111), which is not limited in the embodiments of the present disclosure.

Exemplarily, in an implementation where the base 11 with a groove is formed by assembling a plurality of components, referring to FIG. 4, the base 11 includes a substrate 111, an adhesive layer 112, and a support layer 113. The substrate 111 and the support layer 113 are connected via the adhesive layer 112, and a bottom surface of the groove is disposed on a surface, proximal to the adhesive layer 112, of the substrate 111.

In the implementation, both the adhesive layer 112 in the base 11 and the light source 12 are disposed on the substrate 111, and the support layer 113 for connecting to the polarization beam-splitting layer 13 is disposed on one side, distal to the substrate 111, of the adhesive layer 112. To ensure that the light beam emitted by the light source 12 can be reliably incident on the polarization beam-splitting layer 13, the thicknesses of the light source 12, the adhesive layer 112, and the support layer 113 should all be set within a reasonable range. Moreover, to further ensure the reliable transmission of the light beam, a certain gap should be provided between the polarization beam-splitting layer 13 and the light source 12. That is, the total thickness of the adhesive layer 112 and the support layer 113 is ensured to be greater than the thickness of the light source 12.

For example, the thickness of the light source 12 may be 0.6 to 1.5 millimeter (mm), and the thickness of the adhesive layer 112 may be 0.1 mm. The thickness of the gap between the light source 12 and the polarization beam-splitting layer 13 may be larger than 0 mm and less than or equal to 2 mm. Furthermore, the thickness may be larger than 0 mm and less than or equal to 0.5 mm. For example, the thickness is 0.1 mm.

It can be understood that, in the case that the thickness of the light source 12, the thickness of the adhesive layer 112, and the thickness of the gap between the light source 12 and the polarization beam-splitting layer 13 are all known, the thickness of the support layer 113 can be determined based on the known thickness values.

It can also be understood that the polarization beam-splitting layer 13 may also be directly laminated with the light source 12; that is, there is no gap between the light source 12 and the polarization beam-splitting layer 13, which is not limited in the embodiments of the present disclosure.

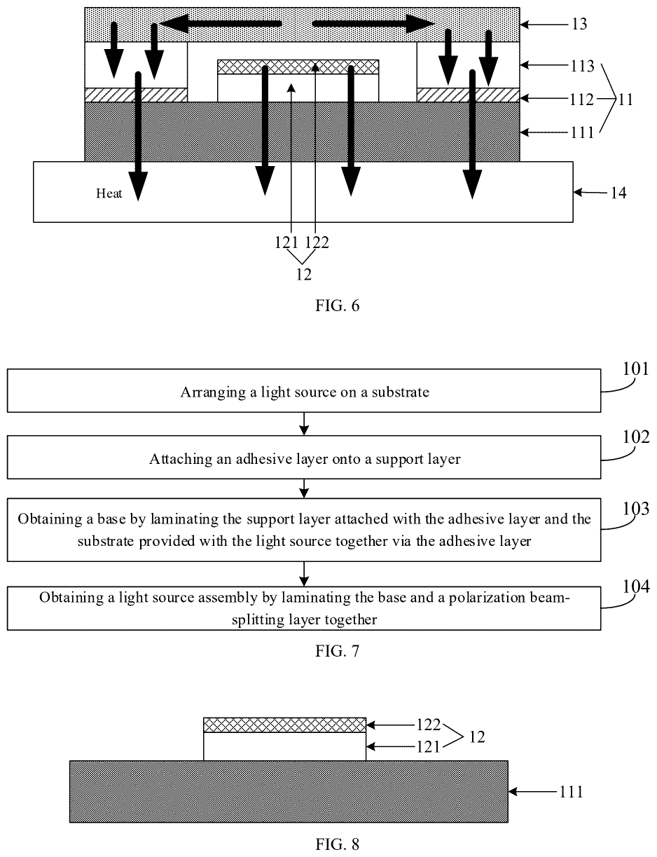

In the embodiments of the present disclosure, since the light beam emitted by the light source 12 carries significant thermal radiation, in order to prevent the various elements through which the light beam passes from being damaged by overheating, a heat sink may be provided in the light source assembly 10 to timely dissipate the heat generated by the light beam emitted by the light source 12. Based on this, the material of the base 11 may be a thermally conductive material, and the light source assembly 10 may further include a heat sink connected to the base 11. For example, referring to FIG. 6, the heat sink 14 is disposed on one side, distal to the light source 12, of the base 11. In a process in which the light source 12 emits a light beam, the heat generated by the light beam can be conducted through the base 11 to the heat sink 14 for dissipation.

In some embodiments, in the case that the base 11 includes a substrate 111, an adhesive layer 112, and a support layer 113, the materials of the substrate 111 and the support layer 113 are metals with thermal conductivity, such as copper (Cu). Alternatively, the materials of the substrate 111 and the support layer 113 are other metallic or non-metallic substances with thermal conductivity. The adhesive layer 112 is an adhesive layer with thermal conductivity.

It can be understood that, in order to improve the efficiency of heat conduction, the material of the polarization beam-splitting layer 13 may also be a thermally conductive material. Thus, the heat generated by the light beam incident on the polarization beam-splitting layer 13 can be conducted sequentially through the polarization beam-splitting layer 13 and the base 11 to the heat sink for dissipation.

It can also be understood that the light source assembly 10 provided according to the embodiments of the present disclosure is applicable not only to a projection device but also to other devices, which are not limited in the present disclosure.

In summary, the embodiments of the present disclosure provide a light source assembly, which includes a light source, a base disposed on a backlight side of the light source, and a polarization beam-splitting layer disposed on a light-emitting side of the light source. The polarization beam-splitting layer can reflect, among the light beams emitted by the light source, a light beam in the second polarization direction that meets the first condition, back to the light source. The light source can convert a portion of the light beam in the second polarization direction, reflected by the polarization beam-splitting layer, into a light beam in a first polarization direction and emit the light beam. Therefore, the utilization rate of the light beam in the second polarization direction emitted by the light source can be effectively improved, thereby increasing the brightness of the projection image projected by the projection device.

Moreover, since the polarization beam-splitting layer is positioned close to the light-emitting side of the light source, the utilization rate of the light beam in the second polarization direction emitted by the light source can be effectively improved, thus further increasing the brightness of the projection image projected by the projection device.

It can be understood that, for the projection device described in the above embodiments, in addition to providing the polarization beam-splitting layer 13 between the light source 12 and the light collecting element 23, a polarization beam-splitting layer may also be provided between elements disposed on the light-incident side of the LCD panel 21 in the light modulation assembly 20, so as to further improve the utilization rate of the light beam in the second polarization direction among the light beams emitted by the light source 12. For example, a polarization beam-splitting layer is provided between the first lens assembly 24 and the heat insulation element 25. Alternatively, the polarization beam-splitting layer is disposed between other elements, which is not limited in the present disclosure.

The embodiments of the present disclosure provide a method for manufacturing a light source assembly, and the method is applicable to manufacturing the light source assembly 10 shown in FIG. 2, FIG. 3, FIG. 4, or FIG. 6. The method includes assembling a light source assembly that includes a base, a light source, and a polarization beam-splitting layer.

In the embodiments of the present disclosure, after the base 11 (or the respective components for assembling the base 11), the light source 12, and the polarization beam-splitting layer 13 have been fabricated, these structures may be assembled to form the light source assembly 10. In the case of assembling the light source assembly 10, the polarization beam-splitting layer 13 is disposed on a light-emitting side of the light source 12, the base 11 is disposed on a backlight side of the light source 12 and outside a transmission path of a light beam between the light source 12 and the polarization beam-splitting layer 13, and the base 11 is connected to the light source 12 and the polarization beam-splitting layer 13.

In the light source assembly 10 obtained after assembly, the light source 12 is configured to emit a first light beam, which includes a light beam in a first polarization direction and a light beam in a second polarization direction. The polarization beam-splitting layer 13 is disposed on a light-emitting side of the light source 12 and is configured to reflect a light beam that meets a first condition to the light source, and transmit a light beam that does not meet the first condition, where the first condition includes an incident angle being greater than or equal to an angle threshold, and a polarization direction being the second polarization direction. The light source 12 is further configured to emit a second light beam based on the light beam in the second polarization direction reflected by the polarization beam-splitting layer 13. The second light beam includes the light beam in the first polarization direction and the light beam in the second polarization direction.

In summary, in the light source assembly manufactured by the method for manufacturing a light source assembly according to the embodiments of the present disclosure, the polarization beam-splitting layer can reflect, among the light beams emitted by the light source, a light beam in the second polarization direction that meets the first condition, back to the light source. The light source can convert a portion of the light beam in the second polarization direction, reflected by the polarization beam-splitting layer, into a light beam in a first polarization direction and emit the light beam. Therefore, the utilization rate of the light beam in the second polarization direction emitted by the light source can be effectively improved, thereby increasing the brightness of the projection image projected by the projection device.

Moreover, since the polarization beam-splitting layer is positioned close to the light-emitting side of the light source, the utilization rate of the light beam in the second polarization direction emitted by the light source can be effectively improved, thus further increasing the brightness of the projection image projected by the projection device.

In the embodiments of the present disclosure, to meet the restrictive condition that the base 11 is disposed on the backlight side of the light source 12 and outside the transmission path of the light beam between the light source 12 and the polarization beam-splitting layer 13, and the base 11 is connected to the light source 12 and the polarization beam-splitting layer 13, referring to FIG. 3, the base 11 is provided with a groove, the light source 12 is disposed within the groove, and the polarization beam-splitting layer 13 covers the opening of the groove. In the case that the base 11 is provided with a groove, the groove can be implemented in various ways. For example, the base 11 is an element formed by assembling a plurality of components and provided with a groove. Based on this, the base 11 may include a substrate 111, an adhesive layer 112, and a support layer 113.

It can be understood that, in the case that the base 11 is provided with a groove, the light source 12 is disposed within the groove, the polarization beam-splitting layer 13 covers an opening of the groove, and the base 11 includes a substrate 111, an adhesive layer 112, and a support layer 123, different methods may be adopted to assemble the light source assembly 10 that includes the base 11, the light source 12, and the polarization beam-splitting layer 13.

In a first implementation, referring to FIG. 7, the method for manufacturing the light source assembly includes the following steps.

In step 101, a light source is arranged on a substrate.

In the embodiments of the present disclosure, the light source 12 is first assembled with the substrate 111 of the base 11. The light source 12 is formed on the substrate 111, or the light source 12 that has already been fabricated is directly attached onto the substrate 111, so as to obtain a structure as shown in FIG. 8. The present disclosure does not limit the manner in which the light source 12 is arranged on the substrate 111.

As shown in FIG. 8, the light source 12 includes a light-emitting chip 121 and a phosphor layer 122 that covers the light-emitting side of the light-emitting chip 121. The light-emitting chip 121 is configured to emit an initial light beam. The phosphor layer 122 is configured to obtain the first light beam based on the initial light beam, and emit the first light beam from one side, distal to the light-emitting chip 121, of the phosphor layer 122; and emit, based on a light beam reflected by the polarization beam-splitting layer 13, the second light beam from one side, distal to the light-emitting chip 121, of the phosphor layer 122.

In step 102, an adhesive layer is attached onto a support layer.

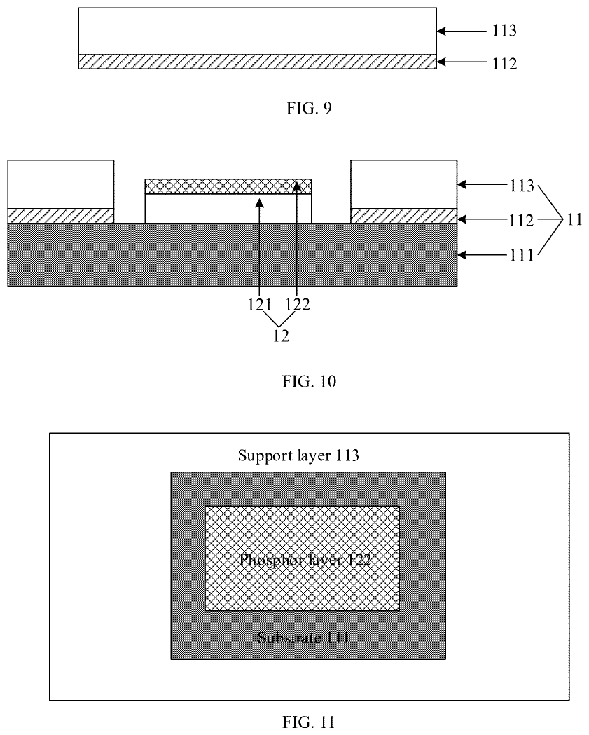

The adhesive layer 112 may be attached onto the support layer 113 by means such as manual operation, a fixture, and a device, resulting in a structure as shown in FIG. 9. The present disclosure does not limit the manner in which the adhesive layer 112 is attached onto the support layer 113.

It can be understood that, to ensure that the light beam emitted by the light source 12 can be reliably incident on the polarization beam-splitting layer 13, the thicknesses of the light source 12, the adhesive layer 112, and the support layer 113 should be set within a reasonable range. Moreover, to further ensure the reliable transmission of the light beam, a certain gap should be provided between the polarization beam-splitting layer 13 and the light source 12; that is, the total thickness of the adhesive layer 112 and the support layer 113 is ensured to be greater than the thickness of the light source 12.

In step 103, a base is obtained by laminating the support layer attached with the adhesive layer and the substrate provided with the light source together via the adhesive layer.

After laminating the support layer 113 attached with the adhesive layer 112 and the substrate 111 provided with the light source 12 together via the adhesive layer, a structure as shown in FIG. 10 can be obtained, where the substrate 111, the adhesive layer 112, and the support layer 113 form the base 11. A bottom surface of a groove of the base 11 is disposed at a surface, proximal to the adhesive layer 112, of the substrate 111; that is, the light source 12 and the adhesive layer 112 are disposed on the same side of the substrate 111, and an orthographic projection of the adhesive layer 112 on the substrate 111 is outside an orthographic projection of the light source 12 on the substrate 111.

FIG. 11 is a top view of the structure shown in FIG. 10. As shown in FIG. 11, the adhesive layer 112 and the support layer 113 in the base 11 surround the light source 12.

In step 104, a light source assembly is obtained by laminating the base and the polarization beam-splitting layer together.

One side, proximal to the base 11, of the polarization beam-splitting layer 13 is also attached with an adhesive layer. The polarization beam-splitting layer 13 is connected to the support layer 113 in the base 11 via the adhesive layer to obtain the light source assembly 10 as shown in FIG. 3.

In some embodiments, as shown in FIG. 5, the polarization beam-splitting layer 13 includes at least one birefringent layer 131. The at least one birefringent layer 131 is in one-to-one correspondence with at least one wavelength. The birefringent layer 131 is configured to reflect a light beam that meets a second condition to the light source 12 and transmit a light beam that does not meet the second condition. The second condition includes a wavelength being a wavelength that corresponds to the birefringent layer, an incident angle being less than or equal to an angle threshold, and a polarization direction being the second polarization direction. The first condition may further include a wavelength belonging to the at least one wavelength.

With continued reference to FIG. 5, the polarization beam-splitting layer 13 further includes two transparent protective layers 132. The at least one birefringent layer 131 is disposed between the two transparent protective layers 132. The two transparent protective layers may both be TAC thin films, serving to protect the birefringent layer 131.

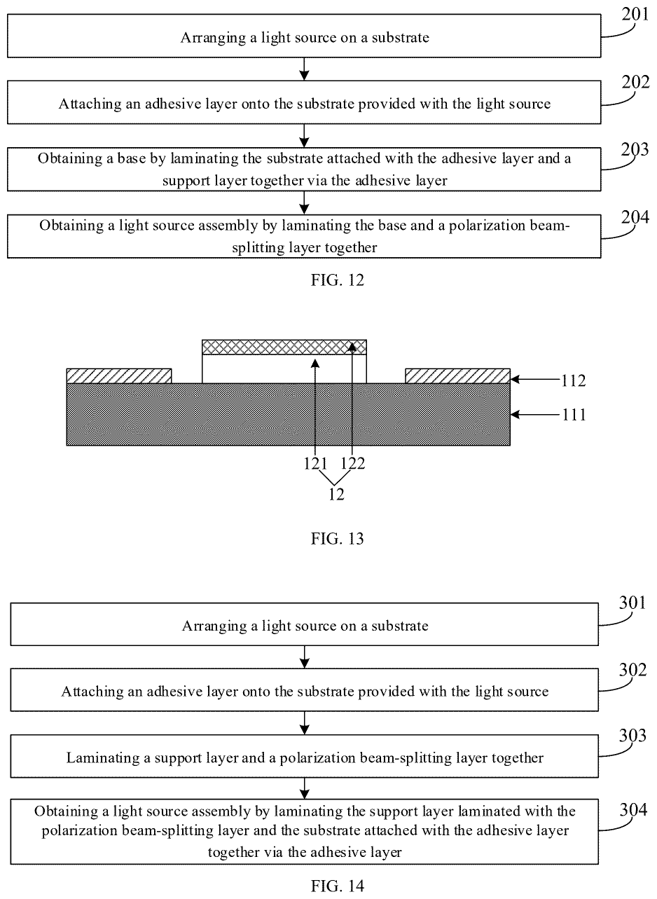

In a second implementation, referring to FIG. 12, the method for manufacturing a light source assembly includes the following steps.

In step 201, a light source is arranged on a substrate.

The implementation process of step 201 may refer to the content of step 101 above. Through this step, a structure as shown in FIG. 8 can be obtained.

In step 202, an adhesive layer is attached onto the substrate provided with the light source.

The adhesive layer 112 may be attached onto the substrate 111 provided with the light source 12 by means such as manual operation, a fixture, and a device, resulting in a structure as shown in FIG. 12. Referring to FIG. 13, the adhesive layer 112 and the light source 12 are disposed on the same side of the substrate 111, and an orthographic projection of the adhesive layer 112 on the substrate 111 is outside an orthographic projection of the light source 12 on the substrate 111.

In step 203, a base is obtained by laminating the substrate attached with the adhesive layer and the support layer together via the adhesive layer.

After laminating the substrate 111 attached with the adhesive layer 112 and the support layer 113 together via the adhesive layer 112, a structure as shown in FIG. 10 can be obtained, where the substrate 111, the adhesive layer 112, and the support layer 113 form the base 11.

A bottom surface of a groove of the base 11 is disposed on a surface, proximal to the adhesive layer 112, of the substrate 111. To ensure reliable transmission of the light beam, the total thickness of the adhesive layer 112 and the support layer 113 after lamination is greater than the thickness of the light source 12.

In step 204, a light source assembly is obtained by laminating the base and the polarization beam-splitting layer together.

The implementation process of step 204 may refer to the content of step 104 above.

As a third implementation, referring to FIG. 14, the method for manufacturing a light source assembly includes the following steps.

In step 301, a light source is arranged on a substrate.

The implementation process of step 301 may refer to the content of step 101 above. The light source 12 is arranged on the substrate 111 to form a structure as shown in FIG. 8.

In step 302, an adhesive layer is attached onto the substrate provided with the light source.

The implementation process of step 302 may refer to the content of step 202 above. The adhesive layer 112 is attached onto the substrate 111 provided with the light source 12 to form a structure as shown in FIG. 13.

In step 303, a support layer and a polarization beam-splitting layer are laminated together.

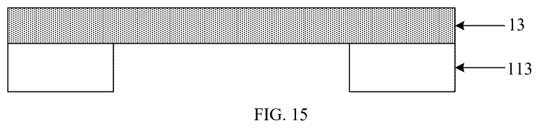

After laminating the support layer 113 and the polarization beam-splitting layer 13 together, a structure as shown in FIG. 15 can be obtained. FIG. 15 is only a sectional view of the structure formed after the support layer 113 and the polarization beam-splitting layer 13 are laminated. In an actual structure, the support layer 113 is annularly laminated to the polarization beam-splitting layer 13.

In step 304, a light source assembly is obtained by laminating the support layer laminated with the polarization beam-splitting layer and the substrate attached with the adhesive layer together via the adhesive layer.

After laminating the support layer 113 laminated with the polarization beam-splitting layer 13 and the substrate 111 attached with the adhesive layer 112 together via the adhesive layer 112, the light source assembly 10 as shown in FIG. 4 can be obtained. A bottom surface of a groove of the base 11 is disposed on a surface, proximal to the adhesive layer 112, of the substrate 111. The substrate 111, the adhesive layer 112, and the support layer 113 form the base 11.

It can be understood that, in addition to the above three implementations, other implementations may also be adopted to assemble the components included in the light source assembly 10 to form the light source assembly 10, which are not limited in the embodiments of the present disclosure.

In the embodiments of the present disclosure, the light source assembly 10 may further include a heat sink 14 connected to the base 11. Based on this, the method for manufacturing a light source assembly may include: assembling a light source assembly that includes the base, the light source, the polarization beam-splitting layer, and the heat sink. For example, referring to FIG. 6, the heat sink is disposed on one side, distal to the light source 12, of the substrate 111. Alternatively, the heat sink 14 may also be arranged in other regions of the base 11, which is not limited in the present disclosure.

The heat sink 14 may be directly laminated with the substrate 111 after the substrate 111 is fabricated. Subsequently, other elements can be arranged on the substrate 111. Alternatively, the heat sink 14 is laminated with the base 11 after the polarization beam-splitting layer 13 is connected to the base 11, which is not limited in the present disclosure.

In summary, in the light source assembly manufactured by the method for manufacturing a light source assembly according to the embodiments of the present disclosure, the polarization beam-splitting layer can reflect, among the light beams emitted by the light source, a light beam in the second polarization direction that meets the first condition, back to the light source. The light source can convert a portion of the light beam in the second polarization direction, reflected by the polarization beam-splitting layer, into a light beam in a first polarization direction and emit the light beam. Therefore, the utilization rate of the light beam in the second polarization direction emitted by the light source can be effectively improved, thereby increasing the brightness of the projection image projected by the projection device.

Moreover, since the polarization beam-splitting layer is positioned close to the light-emitting side of the light source, the utilization rate of the light beam in the second polarization direction emitted by the light source can be effectively improved, thus further increasing the brightness of the projection image projected by the projection device.

It can be understood that the term “at least one” in the present disclosure refers to one or more, and the meaning of “a plurality of” refers to two or more.

In the present disclosure, the terms “first,” “second,” and the like are defined to distinguish the same or similar items with substantially identical functions and functionalities, and it should be understood that “first,” “second,” and “n^{th}” have no logical or sequential dependency relationship, and no limitation on the number or execution sequence.

The descriptions above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A light source assembly, comprising: a base, a light source, and a polarization beam-splitting layer, wherein
the light source is configured to emit a first light beam, the first light beam comprising a light beam in a first polarization direction and a light beam in a second polarization direction;
the polarization beam-splitting layer is disposed on a light-emitting side of the light source and is configured to reflect a light beam that meets a first condition to the light source, and transmit a light beam that does not meet the first condition, wherein the first condition comprises an incident angle being greater than or equal to an angle threshold, and a polarization direction being the second polarization direction;
the light source is further configured to emit a second light beam based on the light beam in the second polarization direction reflected by the polarization beam-splitting layer, the second light beam comprising a light beam in the first polarization direction and a light beam in the second polarization direction; and
the base is disposed on a backlight side of the light source and outside a transmission path of a light beam between the light source and the polarization beam-splitting layer, and the base is connected to the light source and the polarization beam-splitting layer.

2. The light source assembly according to claim 1, wherein the polarization beam-splitting layer comprises at least one birefringent layer, the at least one birefringent layer being in one-to-one correspondence with at least one wavelength;
the birefringent layer is configured to reflect a light beam that meets a second condition to the light source, and transmit a light beam that does not meet the second condition, wherein the second condition comprises a wavelength being a wavelength that corresponds to the birefringent layer, an incident angle being less than or equal to an angle threshold, and a polarization direction being the second polarization direction; and
the first condition further comprises a wavelength belonging to the at least one wavelength.

3. The light source assembly according to claim 2, wherein the polarization beam-splitting layer further comprises two transparent protective layers; and
the at least one birefringent layer is disposed between the two transparent protective layers.

4. The light source assembly according to claim 1, wherein the base is provided with a groove, the light source is disposed within the groove, and the polarization beam-splitting layer covers an opening of the groove.

5. The light source assembly according to claim 4, wherein the base comprises a substrate, an adhesive layer, and a support layer; and
the substrate and the support layer are connected via the adhesive layer, and a bottom surface of the groove is disposed on a surface, proximal to the adhesive layer, of the substrate.

6. The light source assembly according to claim 5, wherein a total thickness of the adhesive layer and the support layer is greater than a thickness of the light source.

7. The light source assembly according to claim 1, wherein a material of the base is a thermally conductive material, and the light source assembly further comprises a heat sink connected to the base.

8. The light source assembly according to claim 1, wherein the light source comprises a light-emitting chip and a phosphor layer that covers a light-emitting side of the light-emitting chip;
the light-emitting chip is configured to emit an initial light beam; and
the phosphor layer is configured to:
obtain the first light beam based on the initial light beam, and emit the first light beam from one side, distal to the light-emitting chip, of the phosphor layer; and
emit, based on a light beam reflected by the polarization beam-splitting layer, the second light beam from one side, distal to the light-emitting chip, of the phosphor layer.

9. The light source assembly according to claim 1, wherein the angle threshold is 30°.

10. A projection device, comprising: a light source assembly and a light modulation assembly, wherein
the light modulation assembly is configured to modulate a light beam from the light source assembly into an image light beam, and project the image light beam; and
the light source assembly comprises a base, a light source, and a polarization beam-splitting layer, wherein
the light source is configured to emit a first light beam, the first light beam comprising a light beam in a first polarization direction and a light beam in a second polarization direction;
the polarization beam-splitting layer is disposed on a light-emitting side of the light source and is configured to reflect a light beam that meets a first condition to the light source, and transmit a light beam that does not meet the first condition, wherein the first condition comprises an incident angle being greater than or equal to an angle threshold, and a polarization direction being the second polarization direction;
the light source is further configured to emit a second light beam based on the light beam in the second polarization direction reflected by the polarization beam-splitting layer, the second light beam comprising a light beam in the first polarization direction and a light beam in the second polarization direction; and
the base is disposed on a backlight side of the light source and outside a transmission path of a light beam between the light source and the polarization beam-splitting layer, and the base is connected to the light source and the polarization beam-splitting layer.

11. The projection device according to claim 10, wherein a light beam emitted by the light source assembly comprises a light beam in a first polarization direction and a light beam in a second polarization direction, and the light modulation assembly comprises a liquid crystal display (LCD) panel; and
the LCD panel is configured to modulate the light beam in the first polarization direction from the light source assembly to obtain the image light beam.

12. A method for manufacturing a light source assembly, comprising:
assembling a light source assembly that comprises a base, a light source, and a polarization beam-splitting layer, wherein the light source assembly is the light source assembly as defined in claim 1.

13. The method according to claim 12, wherein the base is provided with a groove, the light source is disposed within the groove, and the polarization beam-splitting layer covers an opening of the groove; the base comprises a substrate, an adhesive layer, and a support layer; and
said assembling the light source assembly that comprises the base, the light source, and the polarization beam-splitting layer comprises:
arranging the light source on the substrate;
attaching the adhesive layer onto the support layer;
obtaining the base by laminating the support layer attached with the adhesive layer and the substrate provided with the light source together via the adhesive layer, wherein a bottom surface of the groove is disposed on a surface, proximal to the adhesive layer, of the substrate; and
obtaining the light source assembly by laminating the base and the polarization beam-splitting layer together.

14. The method according to claim 12, wherein the base is provided with a groove, the light source is disposed within the groove, and the polarization beam-splitting layer covers an opening of the groove; the base comprises a substrate, an adhesive layer, and a support layer; and
said assembling the light source assembly that comprises the base, the light source, and the polarization beam-splitting layer comprises:
arranging the light source on the substrate;
attaching the adhesive layer onto the substrate provided with the light source;
obtaining the base by laminating the substrate attached with the adhesive layer and the support layer together via the adhesive layer, wherein a bottom surface of the groove is disposed on a surface, proximal to the adhesive layer, of the substrate; and
obtaining the light source assembly by laminating the base and the polarization beam-splitting layer together.

15. The method according to claim 12, wherein the base is provided with a groove, the light source is disposed within the groove, and the polarization beam-splitting layer covers an opening of the groove; the base comprises a substrate, an adhesive layer, and a support layer; and
said assembling the light source assembly that comprises the base, the light source, and the polarization beam-splitting layer comprises:
arranging the light source on the substrate;
attaching the adhesive layer onto the substrate provided with the light source;
laminating the support layer and the polarization beam-splitting layer together; and
obtaining the light source assembly by laminating the support layer laminated with the polarization beam-splitting layer and the substrate attached with the adhesive layer together via the adhesive layer, wherein a bottom surface of the groove is disposed on a surface, proximal to the adhesive layer, of the substrate.

16. The projection device according to claim 10, wherein the polarization beam-splitting layer comprises at least one birefringent layer, the at least one birefringent layer being in one-to-one correspondence with at least one wavelength;
the birefringent layer is configured to reflect a light beam that meets a second condition to the light source, and transmit a light beam that does not meet the second condition, wherein the second condition comprises a wavelength being a wavelength that corresponds to the birefringent layer, an incident angle being less than or equal to an angle threshold, and a polarization direction being the second polarization direction; and
the first condition further comprises a wavelength belonging to the at least one wavelength.

17. The projection device according to claim 16, wherein the polarization beam-splitting layer further comprises two transparent protective layers; and
the at least one birefringent layer is disposed between the two transparent protective layers.

18. The projection device according to claim 10, wherein the base is provided with a groove, the light source is disposed within the groove, and the polarization beam-splitting layer covers an opening of the groove.

19. The projection device according to claim 18, wherein the base comprises a substrate, an adhesive layer, and a support layer; and
the substrate and the support layer are connected via the adhesive layer, and a bottom surface of the groove is disposed on a surface, proximal to the adhesive layer, of the substrate, wherein a total thickness of the adhesive layer and the support layer is greater than a thickness of the light source.

20. The projection device according to claim 10, wherein a material of the base is a thermally conductive material, and the light source assembly further comprises a heat sink connected to the base.
